(19) United States
(12) Patent Application Publication
(10) Pub. No.: US 2004/0049841 A1
(43) Pub. Date: Mar. 18, 2004

(54) Commode chair

(76) Inventors: Ian Brotherston, Listowel (CA); Michael B. Truelove, Stratford (CA)

Correspondence Address: Mark W. Sajewycz, Gowling Lafleur Henderson, Commerce Court West, Suite 4900, Toronto, ON, M5L 1J3, CA

(21) Appl. No.: 09/745,522

(22) Filed: Dec. 26, 2000

Related U.S. Application Data
(63) Continuation-in-part of application No. 09/417,475, filed on Oct. 13, 1999, now abandoned.

(30) Foreign Application Priority Data
Jul. 17, 2000 (WO) PCT/CA00/00836

(51) Int. Cl. A61G 7/02; A47K 11/06

(52) U.S. Cl. 4/480

(57) ABSTRACT

A commode chair is provided having a seat comprising a generally central opening, a lateral outer edge and a support surface disposed between the lateral outer edge and the opening sloping downwardly in a direction towards the opening. The seat includes a depression disposed between the right lateral outer edge and a left outer edge, rearwardly of a front outer edge, and extending forwardly from the opening. The seat is pivotally coupled to a frame and has a first seating position and a second seating position, wherein the first seating position is characterized by a position of tilt which is different than that of the second seating position. The commode chair further includes a backrest pivotally coupled to the frame and having a first backrest position and a second backrest position, wherein the first backrest position is characterized by a position of inclination which is different than that of the second backrest position and wherein at least one of the first backrest position and the second backrest position has a position of inclination forward of vertical. The chair also includes an armrest disposed laterally from the lateral outer edge and capable of lateral movement relative to the seat.

### FIELD OF INVENTION

The present invention relates to commode chairs and, in particular, relates to commode chairs which are positionable for assisting exit and entry from the chair and for facilitating defecation by persons using the chair.

### BACKGROUND OF THE INVENTION

Physically challenged persons require comfortable and convenient toilet seating facilities. To this end, known commode chairs have been designed to offer basic support for the back, buttocks, arms, legs and feet for persons using such chairs.

Known commode chairs, such as those disclosed in U.S. Pat. Nos. 5,343,573 and 5,289,596, include seats which are substantially horizontal and flat. Also, the backrests of known commode chairs have limited positioning capabilities. U.S. Pat. Nos. 5,110,183 and 5,224,754 disclose a commode chair with a positionable backrest. However, positioning capabilities of the associated backrest is limited.

In this respect, known commode chairs, although satisfying basic support requirements, do not provide for optimum positioning of persons using these chairs in regards to assisting such persons when defecating. Further, the design of such commode chairs does little to assist a health care professional who is attempting to seat a physically challenged person in or lift such person out of the commode chair.

### SUMMARY OF INVENTION

The present invention provides a commode chair having a seat comprising a generally central opening, a lateral outer edge, and a support surface disposed between the lateral outer edge and the opening sloping downwardly in a direction towards the opening.

In one aspect, a commode chair is provided having a seat comprising a generally central opening, a right lateral outer edge and a left lateral outer edge, a front outer edge and a rear outer edge, and a depression disposed between the right lateral outer edge and the left lateral outer edge, rearwardly of the front outer edge, and extending forwardly from the opening.

In another aspect, a commode chair is provided comprising a frame, and a seat having a generally central opening, the seat being pivotally coupled to the frame and having a first seating position and a second seating position. The first seating position is characterized by a position of tilt which is different than that of the second seating position.

In yet another aspect, a commode chair is provided comprising a frame, a seat having a generally central opening, and a backrest pivotally coupled to the frame and having a first backrest position and a second backrest position. The first backrest position is characterized by a position of inclination which is different than that of the second backrest position. At least one of the first backrest position and the second backrest position has a position of inclination forward of vertical.

In yet a further aspect, a commode chair is provided comprising a seat having a generally central opening and a lateral outer edge, and an armrest disposed laterally from the lateral outer edge and having a first armrest position and a second armrest position. The first armrest position is characterized by a lateral position which is different than that of the second armrest position.

By providing support surfaces which slope downwardly in a direction towards the generally central opening, the thighs of a person sitting in the chair will tend to roll in a generally inward direction, which facilitates defecation. The depression helps reduce the risk that male persons using the chair will not suffer injury to their genitalia as they are removed from the chair by their caregivers. Further, by being able to incline the backrest forward of vertical, a person sitting in the chair will be forced to bend forwards, and thereby adopt a more favourable position for defecation. Similarly, the tiltability of the seat also facilitates defecation, and further assists a caregiver in removing persons from the chair particularly when the seat is tilted at an angle below the horizontal. The lateral moveability of the armrests is also advantageous because it facilitates adaptability of the chair to persons of various body sizes.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front perspective view of a commode chair of the present invention;

FIG. 2 is a back elevation view of a commode chair of the present invention;

FIG. 3 is a side elevation view of the commode chair of the present invention, having a backrest which is shown reclined at an angle rearward of vertical;

FIG. 4 is a side elevation view of the commode chair of the present invention, having a backrest which is shown reclined at an angle forward of vertical;

FIG. 5 is a top plan view of a commode chair seat of the present invention;

FIG. 6 is a front elevation view of a commode chair seat of the present invention;

FIG. 7 is a front perspective view of another embodiment of the present invention;

FIG. 8 is a detailed drawing of an embodiment of an extendible support member of the commode chair of the present invention; and

FIG. 9 is a perspective view of another embodiment of a commode chair seat of the present invention.

### DETAILED DESCRIPTION

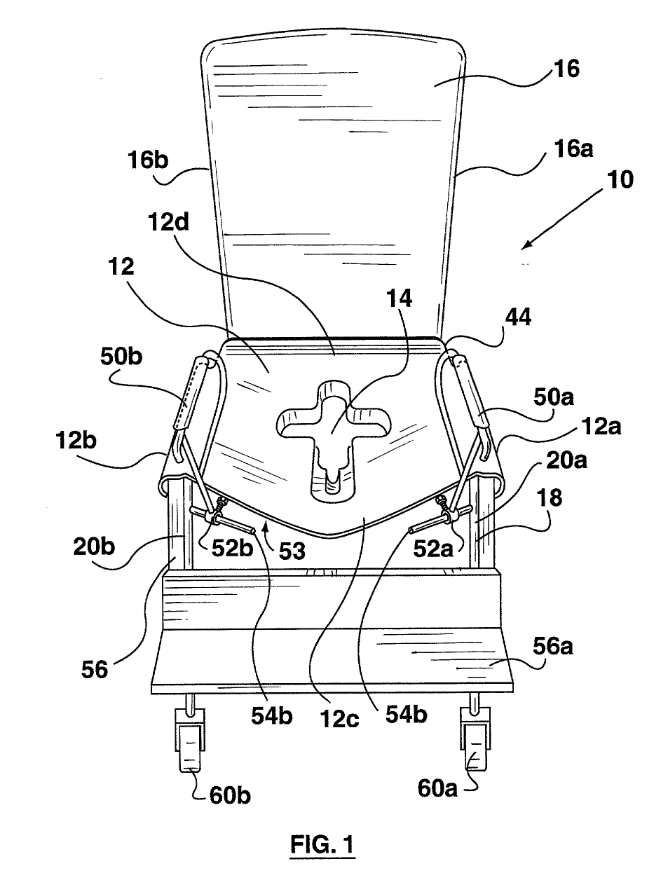

Referring to FIGS. 1,2, 3 and 4, a commode chair 10 is illustrated comprising a seat 12 with a generally central opening 14, a backrest 16, and a frame 18 which supports the seat 12 and backrest 16 on a floor surface. The seat has lateral sides 12a,12b and the backrest 16 has lateral sides 16a,16b.

Backrest lateral sides 16a,16b are pivotally coupled to seat lateral sides 12a,12b respectively to allow backrest to be positioned at a desired degree of inclination relative to the floor surface. Backrest 16 is further supported by extendible support members 26a,26b. Extendible support members 26a,26b allow backrest 16 to be locked in a fixed position of inclination. Each of the extendible support members 26a,26b is pivotally coupled at one end to the backrest 16, and is further coupled at another end to strut members 28a,28b which are in turn fixedly coupled to the seat 12. Strut members 28a,28b can also be fixedly coupled anywhere on frame 18 so long as the backrest 16 is able to change its position of inclination in response to a change in extension of support members 26a,26b. Backrest 16 and extendible support members 26a,26b co-operate such that backrest 16 is capable of being fixedly positioned at an angle forward of vertical. The vertical position is defined as the position where the backrest 16 is disposed at an angle of about 90° relative to the seat 12. Preferably, the backrest 16 is positionable at an angle of at least about 5° forward of vertical. More preferably, the backrest 16 is positionable at an angle of at least about 10° forward of vertical. When a person is sitting in chair 10, the forward inclination of backrest 16 causes such person to bend forwards, and thereby adopt a bodily position which is conducive to defecation.

The frame 18 comprises a pair of fixed front support members 20a,20b pivotally coupled to a front portion 12c of seat 12, and a pair of extendible rear support members 22c,22d pivotally coupled to a rear portion 12d of seat 12. The rear support members 22c,22d are made extendible to effect support and positioning of the seat 12 at various angles of tilt. The front support members 20a,20b and rear support members 22c,22d are engaged to a common base 24 to form frame 18. Seat 12 and extendible support members 22c,22d co-operate such that seat 12 is capable of being fixedly positioned at an angle ranging from 20° above the horizontal to 45° below the horizontal.

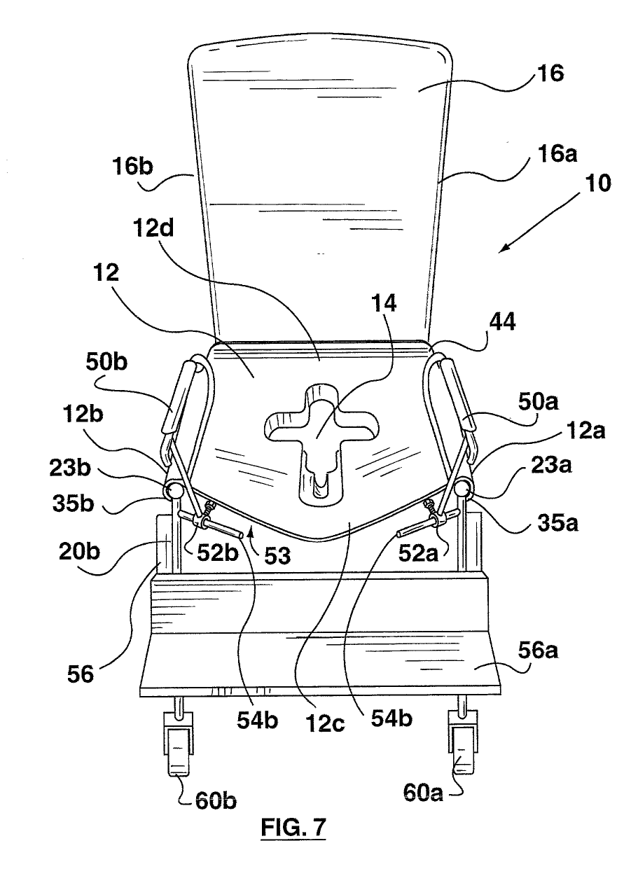

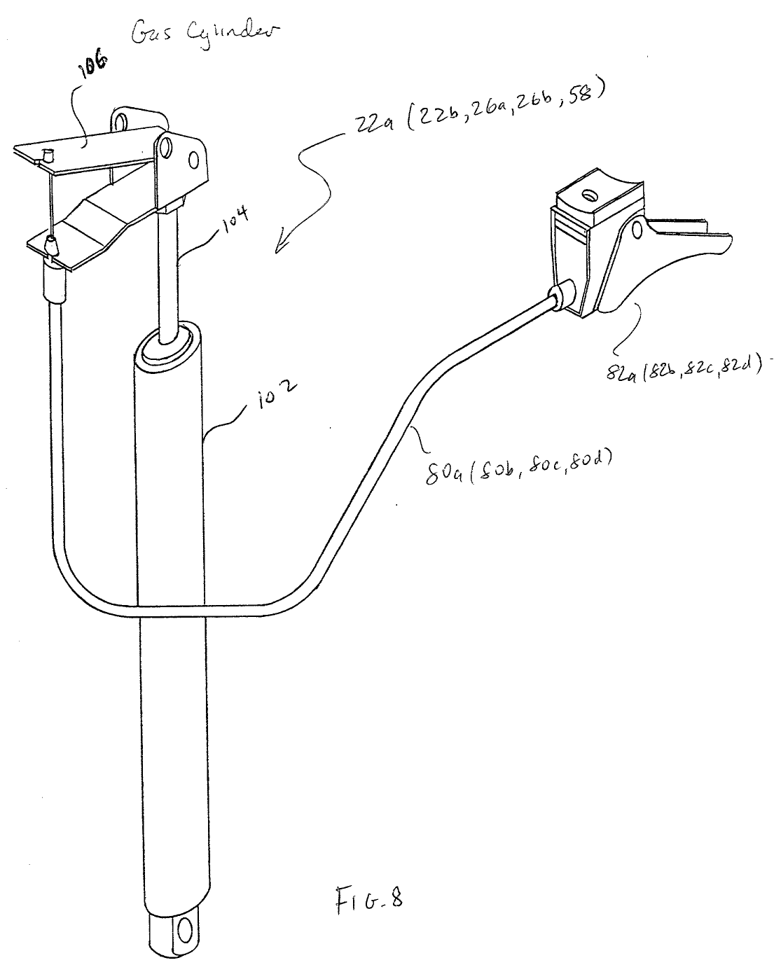

Referring to FIG. 7, in one embodiment, frame 18 further includes upper lateral frame members 23a,23b pivotally coupled to and extending rearwardly from front support members 20a,20b on either side of chair 10. Seat 12 includes lateral sides 12a and 12b which are coupled to frame members 23a,23b in snap fit engagement. In this respect lateral sides 12a and 12b are formed with outer edges 32a and 32b which include downward reverse bends 33a and 33b to form arcuate flanges 35a and 35b (see FIG. 6). Arcuate flanges 35a and 35b mate with frame members 23a and 23b for frictional engagement or snap fit engagement thereto.

In this respect, chair 10 includes both back recline and seat tilt capabilities. Advantageously, backrest 16 can be inclined forward of vertical and seat 12 can be tilted below the horizontal, simultaneously. By providing forward inclination of backrest 16, a person sitting in chair 10 will be forced to bend forwards, thereby facilitating defecation. Further, because seat 12 is tilted below the horizontal, the centre of gravity of such person will be moved rearwardly. Therefore, when in this configuration, backrest 16 will simultaneously provide support to a person sitting in chair 10 while causing the person to bend in a forwardly direction. Preferably, to effect this desired positioning, backrest 16 is positioned at an angle of at least 5° forward of vertical and seat 12 is positioned at an angle of at least 5° below horizontal.

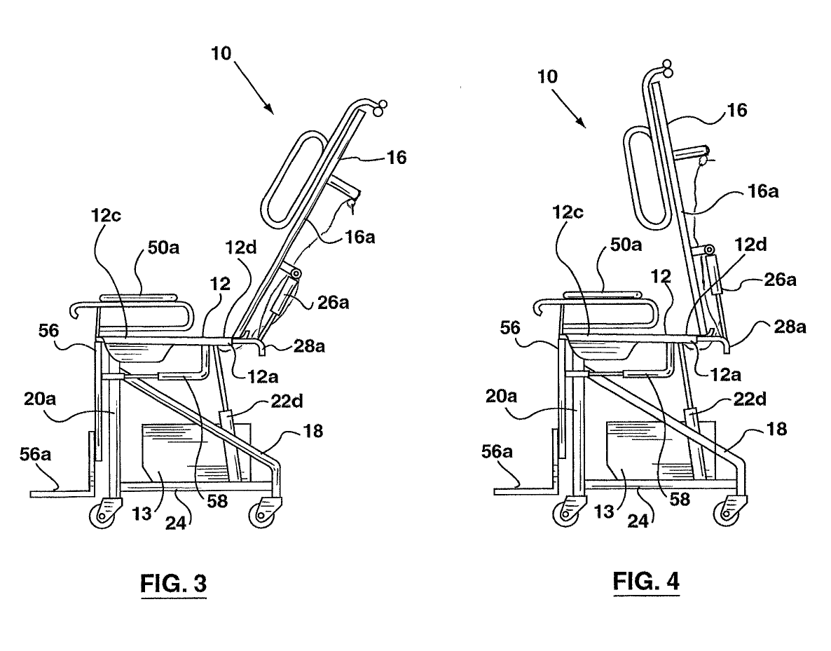

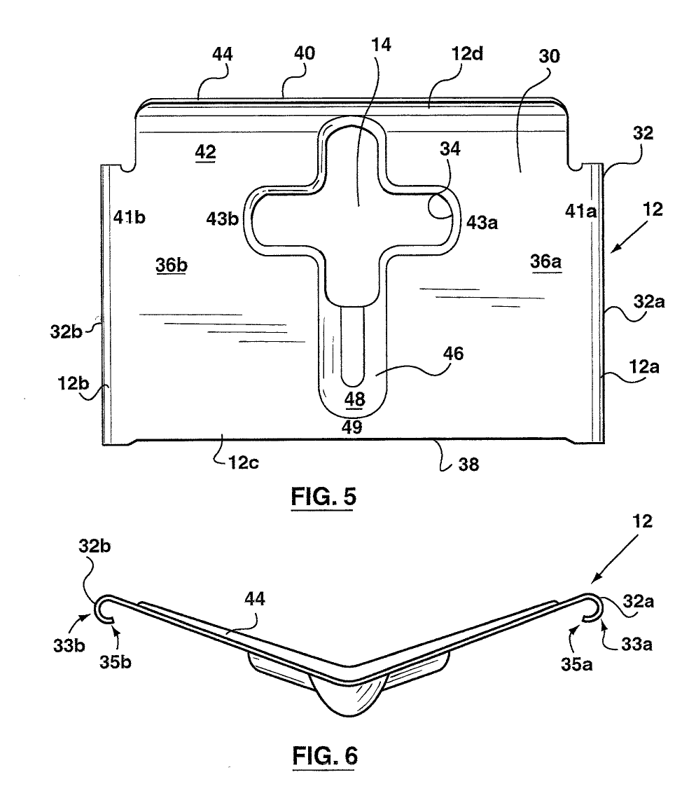

Referring to FIGS. 5 and 6, seat 12 includes a generally central opening 14 to facilitate drainage of body wastes from a person sitting in chair 10 into a receptacle 13 (see FIGS. 3 and 4), and a perimeter 30 surrounding opening 14. Perimeter 30 provides support to a person sitting in chair 10. Perimeter 30 has a surface defined by lateral outer edge 32 and an inner edge 34. Lateral outer edge 32 includes right lateral outer edge 32a and left lateral outer edge 32b. The inner edge 34 helps define a space which serves as the opening 14 to facilitate drainage of body wastes.

The perimeter 30 has support surfaces 36a,36b between each of the right and left lateral outer edges 32a,32b and the opening 14. More particularly, the surfaces 36a,36b are disposed between a front outer edge 38 and a rear outer edge 40 of seat 12. The support surface 36a or 36b slopes downwardly in a direction towards the opening 14, such that support surfaces 36a,36b provide a reaction surface to cause the thighs of a person sitting in chair 10 to roll in a generally outward direction. The support surfaces 36a,36b slope downwardly at an angle of at least 5° below the horizontal. Preferably, this angle is at least 10° below the horizontal. More preferably, this angle is at least 15° below the horizontal. Most preferably, this angle is at least 20° below the horizontal. Preferably, support surfaces 36a,36b have a length of at least 4 cm in the direction of the slope. In the embodiment illustrated in FIG. 6, the support surface 36a extends from a region 41a proximate the right lateral outer edge 32a to a region 43a proximate the opening 14. Similarly, the support surface 36b extends from a region 41b proximate the left lateral outer edge 32b to a region 43b proximate to the opening 14. By providing support surfaces 36a,36b, the body of a person sitting in the chair 10 will adopt a desirable position in regards to facilitating defecation. In particular, bowel movement of a person sitting in chair 10 is greatly facilitated in response to having his or her thighs rolled inwardly.

The seat 12 further includes a support surface 42 positioned rearwardly of the opening 14 and a weir 44 extending upwardly from the surface 42. The weir 44 is substantially perpendicular to the surface. In this respect, weir 44 provides a barrier to contain body wastes should the body wastes of a person using chair 10 inadvertently travel towards to rear end of seat 12 rather than draining through opening into an associated receptacle 13.

In one embodiment, seat 12 further includes a depression 46, disposed generally between lateral outer edges 32a and 32b, rearwardly of front outer edge 38, and extending forwardly from opening 14. The depression 46 gradually slopes downwardly from a region 49 rearward of front outer edge, to form sloping surface 48, and extends to the inner edge 34 or opening 14. Preferably, the sloping surface 48 is substantially uninterrupted and gradual. People who use these chairs often require assistance from caregivers in being removed from the chair 10. In doing so, caregivers typically remove such persons from across the front side edge of seat 12. By providing this depression, men who use these chairs 10 are less likely to suffer injury to their genitalia when being removed from the chair 10 by the caregiver.

Referring to FIGS. 1, 3 and 4, the chair 10 further comprises first and second armrests 50a and 50b positioned adjacent to each of the lateral sides 12a and 12b of seat 12. Each armrest is laterally moveable with respect to the seat 12. In this respect, the armrest 50a or 50b is releasably mounted on the chair 10 with releasable clamps 52a,52b. In one embodiment, the armrest 50a or 50b is slidably mounted on the underside 53 of seat 12. In this respect, the underside 53 of seat 12 includes frame member 54a and 54b disposed substantially perpendicular to the plane defined by the armrest 50a or 50b. Armrests 50a and 50b are mounted on the corresponding frame members 54a and 54b by releasable clamps 52a and 52b.

A footrest 56 is also provided, having a footplate 56a and leg rest 56b for supporting the feet and legs respectively of a person sitting in chair 10. Footrest 56 can be engaged to the front end of frame 18. In one embodiment, the footrest 56 is probably connected to frame 18 for pivotal rotation about pivot point. Extendible support member 58 is provided to effect support and positioning of footrest 56 at various elevated positions above the floor surface. In another embodiment, the footrest 56 can be engaged to seat 12, thereby travelling with seat 12 as seat 12 is positioned and re-positioned at various angles of tilt. In yet another embodiment, footrest 56 can be operatively connected to backrest 16. In this respect, the footrest 56 becomes elevated or lowered in response to recline and incline respectively of backrest 16.

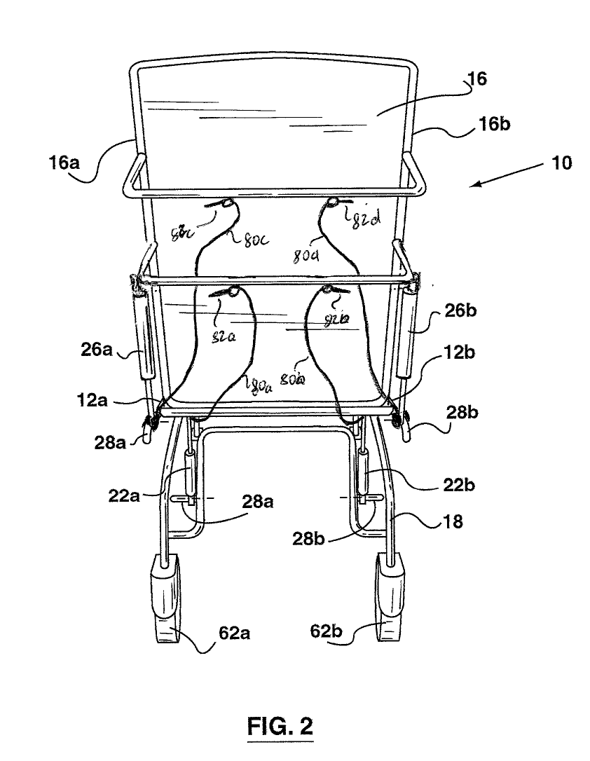

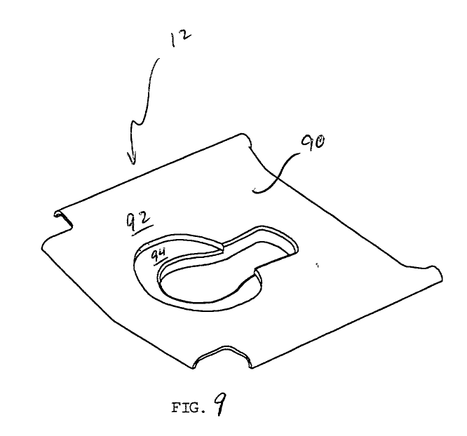

In the embodiment shown in FIGS. 1 and 2, extendible support members 22a, 22b, 26a, 26b and 58 include gas springs containing a compressible gas which exert an upward force on corresponding members which they support to resist a downward weight of a person sitting in the chair 10. A suitable gas spring is a BLOC-O-LIFT spring locking gas spring using a Bowden cable system, and as manufactured by Stabilus GMBH. A detailed drawing of the extendible support members 22a,22b, 26a,26b, and 58, comprising gas springs, is provided in FIG. 8.

The gas spring is a closed system consisting of a pressure tube 102 and a hollow piston rod 104 extending from the pressure tube 102. Piston rod 102 terminates in a piston within pressure tube 102. A compressed gas is provided within tube 102. The pressure tube 102 is separated into first and second chambers by a valve (not shown). The valve is actuated by a release pin which extends from the valve and through the piston rod 104, and extends externally of the piston rod 104 for actuation by release plate 106. When the valve is open in response to depression of the release pin, the piston rod will be extended in a controlled, dampered manner at the defined gas spring force. The piston rod can further be compressed by application of an external force to overcome the gas spring force when the valve is open. As soon as the actuator pin is released from the outside, the valve will close automatically because of the gas pressure exerted on it. The piston or piston rod is then locked, as gas exchange between the chambers is interrupted. The cylinders may thus be releasably locked in a desired position when the chair seat 12 or backrest 16 is tilted to a desired position. In one embodiment, such valve is manually controlled by wires 80a,80b, 80c, 80d, and associated manual levers 82a,82b, 82c,82d which thereby control locking of the cylinders (see FIG. 2). Alternatively, such extendible support members can be lockable helical springs or a ratchet mechanism.

Front wheels 60a,60b and rear wheels 62a,62b extend downwardly from frame 18 to allow health care professionals to easily transport patients who may be sitting or reclining in the commode chair 10.

FIG. 9 illustrates a further embodiment of commode chair seat 12, wherein chair seat 12 includes a seating surface 90 including a raised surface 92 and a recessed surface 94. The recessed surface 94 is disposed proximate to and extends from opening 14, but is spaced inwardly from all edges of the seat 12.

It will be understood, of course, that modifications can be made in the embodiments of the invention described herein without departing from the scope and purview of the invention as defined by the appended claims.

1. A commode chair having a seat comprising:
a generally central opening;
a lateral outer edge; and
a support surface, disposed between the lateral outer edge and the opening, sloping downwardly in a direction towards the opening.

2. The commode chair as claimed in claim 1 wherein the seat further comprises a front outer edge and a rear outer edge, the support surface being disposed between the front outer edge and the rear outer edge.

3. The commode chair as claimed in claim 1 wherein the seat further comprises a right lateral outer edge and a left lateral outer edge, the opening being disposed between the right and left lateral outer edges, and a first support surface disposed between the right lateral outer edge and the opening sloping downwardly in a direction towards the opening and a second support surface disposed between the left lateral outer edge and the opening sloping downwardly in a direction towards the opening.

4. The commode chair as claimed in claim 3 wherein the seat further comprises a front outer edge and a rear outer edge, each of the first and second support surfaces being disposed between the front outer edge and the rear outer edge.

5. The commode chair as claimed in claim 4 wherein the first support surface extends from a region proximate the right lateral outer edge to a region proximate the opening and the second support surface extends from a region proximate the left lateral outer edge to a region proximate the opening.

6. The commode chair as claimed in claim 5 wherein sloping of the support surface is at an angle of at least 5° below the horizontal.

7. The commode chair as claimed in claim 5 wherein sloping of the support surface is at an angle of at least 10° below the horizontal.

8. The commode chair as claimed in claim 5 wherein sloping of the support surface is at an angle of at least 20° below the horizontal.

9. The commode chair as claimed in claim 5 wherein the support surface has a length of at least 4 cm in the direction of the slope.

10. The commode chair as claimed in claim 5 wherein the seat further comprises a third support surface positioned rearwardly of the opening and a weir extending upwardly from the third support surface.

11. The commode chair as claimed in claim 10 wherein the weir is substantially perpendicular to the third support surface.

12. The commode chair as claimed in claim 5 wherein the seat further comprises a depression disposed between the right lateral outer edge and the left lateral outer edge, rearwardly of the front outer edge, and extending forwardly from the opening.

13. The commode chair as claimed in claim 12 wherein the depression slopes downwardly from a point rearward of the front outer edge to form a sloping surface extending to the opening.

14. The commode chair as claimed in claim 13 wherein the downward sloping of the sloping surface is substantially uninterrupted.

15. The commode chair as claimed in claim 14 wherein the downward sloping is substantially gradual.

16. A commode chair having a seat comprising:
a generally central opening;
a right lateral outer edge and a left lateral outer edge;
a front outer edge and a rear outer edge; and
a depression disposed between the right lateral outer edge and the left lateral outer edge, rearwardly of the front outer edge, and extending forwardly from the opening.

17. The commode chair as claimed in claim 16 wherein the depression slopes downwardly from a point rearward of the front outer edge to form a sloping surface extending to the opening.

18. The commode chair as claimed in claim 17 wherein the downward sloping of the sloping surface is substantially uninterrupted.

19. The commode chair as claimed in claim 18 wherein the downward sloping is substantially gradual.

20. A commode chair comprising:
a frame; and
a seat having a generally central opening, the seat being pivotally coupled to the frame and having a first seating position and a second seating position, wherein the first seating position is characterized by a position of tilt which is different than that of the second seating position.

21. The commode chair as claimed in claim 20 wherein the chair further comprises a first extendible support member, adapted to cause the seat to resist a downward weight of a person sitting on the seat and thereby support the seat.

22. The commode chair as claimed in claim 21 wherein the first extendible support member is pivotally coupled at one end to the seat and adapted to apply a force upwardly on the seat.

23. The commode chair as claimed in claim 22 wherein the first extendible support member is releasably lockable.

24. The commode chair as claimed in claim 23 further comprising a backrest pivotally coupled to the frame and having a first backrest position and a second backrest position, wherein the first backrest position is characterized by a position of inclination which is different than that of the second backrest position.

25. The commode chair as claimed in claim 24 wherein at least one of the first backrest position and the second backrest position has a position of inclination forward of vertical.

26. The commode chair as claimed in claim 25 wherein the position of inclination forward of vertical is at least 5° forward of vertical.

27. The commode chair as claimed in claim 26 further comprises a second extendible support member adapted to support the backrest in a desired position of inclination.

28. The commode chair as claimed in claim 27 wherein the first seating position or the second seating position is characterized by a position of tilt having an angle of at least 5° below horizontal.

29. A commode chair comprising:
a frame;
a seat having a generally central opening; and
a backrest pivotally coupled to the frame and having a first backrest position and a second backrest position, wherein the first backrest position is characterized by a position of inclination which is different than that of the second backrest position, and wherein at least one of the first backrest position and the second backrest position has a position of inclination forward of vertical.

30. The commode chair as claimed in claim 29 wherein the position of inclination forward of vertical is at least 5° forward of vertical.

31. The commode chair as claimed in claim 30 further comprises a second extendible support member adapted to support the backrest in a desired position of inclination.

32. A commode chair comprising:
a seat having a generally central opening and a lateral outer edge;
an armrest disposed laterally from the lateral outer edge and having a first armrest position and a second armrest position, wherein the first armrest position is characterized by a lateral position which is different than that of the second armrest position.

33. The commode chair as claimed in claim 32 wherein the armrest is laterally moveable relative to the seat.

34. The commode chair as claimed in claim 33 wherein the armrest is releasably coupled to the chair.

35. The commode chair as claimed in claim 34 wherein the armrest is releasably coupled to the seat.

36. A commode chair comprising:
first and second lateral frame members; and
a seat having a generally central opening first and second lateral edges corresponding to the first and second frame members respectively, each of the lateral edges including a downward reverse bend to form a flange wherein the flange engages each of the respective frame members in snap fit engagement.
